(19) United States
(12) Patent Application Publication
(10) Pub. No.: US 2003/0048755 A1
(43) Pub. Date: Mar. 13, 2003

(54) Mobile computer which is connected to several connection units

(76) Inventor: Anders Ruland, Malmo (SE)

Correspondence Address: Diane Dunn McKay, Mathews Collins Shepherd & Gould, Suite 306, 100 Thanet Circle, Princenton, NJ, 08540, US

(21) Appl. No.: 10/240,833

(22) PCT Filed: Apr. 5, 2001
(86) PCT No.: PCT/SE01/00757

(30) Foreign Application Priority Data
Apr. 5, 2000 (SE) 0001223-7

(51) Int. Cl. H04B 7/212

(52) U.S. Cl. 370/252; 370/401

(57) ABSTRACT

A method in a mobile computer, a first connection between the computer and a server being established. In the server, a user program is executed, which transmits output data for indication of the mobile computer via the first connection. The mobile computer transmits input data to the user program via the first connection, which continuously is compared to at least one second connection. The first connection is replaced by a second connection when certain conditions are met. Then, henceforth input data and output data are transferred via the second connection during continued indication of output data of the mobile computer and during continued comparison with at least the first connection.

### FIELD OF THE INVENTION

The invention relates to a method in a mobile computer. The term mobile computer relates to a computer that comprises an input member and indicating member as well as at least one communication member for communication with an external computer, The mobile computer also comprises a control member for control of other members.

The mobile computer communicates with an external computer, in which one or more user programs are executed. The user program is affected by input data from the input member of the mobile computer and transmits output data to the indicating member of the mobile computer.

### PRIOR ART

A mobile computer, or a so-called thin client, presently exists in different embodiments. In one embodiment, a communication member is included for packet switched communication, e.g. according to anyone of the systems GPRS (General Packet Radio Service), EDGE (Enhanced Data rates for Global Evolution) or UMTS (Universal Mobile Telecommunication System), with the external computer. The external computer is more powerful than the mobile computer and is configured, like a server, to execute application programs for other computers, so-called clients.

The above-mentioned systems for communication work well at large distances between client and server, but are relatively expensive to use. Other, more locally directed, systems are cheaper to use, but have a more limited and local field of use. Among such local systems, the so-called BLUETOOTH and different system for IR communication may be mentioned.

For many applications it would be desirable to broaden the working range for mobile computers, without the costs for utilization of the communication systems becoming too high.

### THE INVENTION IN SUMMARY

Therefore, an object of the invention is to provide a method where packet switched communication and similar communication systems may be combined with other communication systems. According to the method, one of a plurality of connections between a mobile computer and an external computer may be chosen depending on certain conditions,

The mobile computer has an input member, e.g. a keyboard, and an indicating member, e.g. a display. Furthermore, the mobile computer to is provided with communication members for the different types of connections that are in question. A control unit continuously monitors the status of the different communication members and which connections that are feasible.

An established active connection between the mobile computer and the server implies that a user program is executed in the server. Output data from the program are transferred via the connection to the mobile computer and are made available for the user on the display. The user controls and actuates in a common way the user program by inputting control data on the keyboard. Signals corresponding to these control data are transferred via the connection to the server.

At fulfilment of certain conditions, the control unit will interrupt the connection that is active and in instead establish a new connection. This may take place without necessarily affecting the execution of the user program. Neither needs the display of the mobile computer be effected.

### BRIEF DESCRIPTION OF THE DRAWINGS

The invention will now be closer described by means of embodiment examples while referring to the appended drawings, in which

Fig 1 is a schematic block diagram of a device according to an embodiment of the invention, and

FIG. 2 is a flow chart for the control of the device in FIG. 1.

### THE INVENTION

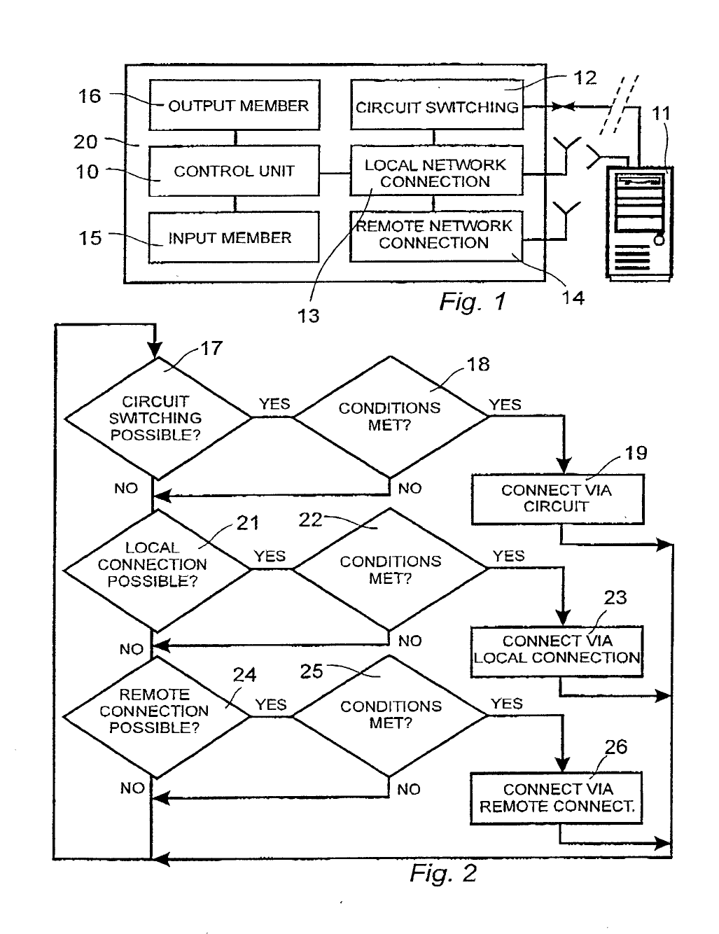

A schematic embodiment of a device according to the invention is shown in FIG. 1. The device in the form of a mobile computer 20, the outer shape of which may correspond to a conventional portable computer, comprises a control unit 10. The control unit 10 controls other units of the device. A plurality of different connection possibilities to an external computer 11 is included in the device. In the embodiment according to FIG. 1, a first connecting unit 12 is included in the form of a circuit switching unit for direct physical connection with the external computer 11. The circuit switching unit 12 may comprise a conventional network card or the like hardware.

In the embodiment shown, also a second connecting unit 13 is included in the form of a communication member for local wireless communication, e.g. BLUETOOTH, and a third connecting unit 14 for wireless remote communication, e.g. GPRS. All connecting units continuously monitor their channels for communication.

When a connection has been established between the device and the external computer 11, an input member 15 and an output member 16 of the device are used to start and then to control the execution of user programs of the external computer 11. The input member 15 may be a conventional keyboard or any form of touch screen. Such a touch screen may also constitute part of the output member 16, which in another case may comprise a conventional screen.

The control unit 10 monitors the connecting units and chooses a connecting unit depending on adjustable conditions It is possible to set the control unit so that status and feasible connections in question continuously are indicated on the output member. Thereby, the user may control the choice of connection and which connecting unit that is to be used for communication. It is also possible to set the control unit beforehand so that the connecting units are selected automatically in a certain order of priority. Suitably, the circuit switching unit 12 is selected, when this is possible.

A control program executing in the control unit may comprise the functional steps that are shown in FIG. 2. It should be noted that the shown functional steps constitute a portion of the control program relevant for the invention, which program in addition comprises other and conventional portions for handling input and output data and for indication of information on the output member.

In a first step 17, the control unit 10 checks if circuit switching with the first connecting unit 12 is feasible. If that is the case, it is checked in a second step 18 if the current conditions of the application in question are met. Within the scope of the second step 18, the user may, via the output member 16, be informed about the feasible connection mode. The user may in that connection give his go-ahead as a part of the control if the conditions are met. If all conditions are met, a connection via the circuit switching takes place in a third step 19. Checking of feasible connection modes then continues by returning to the first step 17.

If the checking in the first step 17 results in that any circuit switching is not feasible, it is instead checked, in a fourth step 21, if a wireless connection to a local network is feasible. If that is the case, it is checked in a fifth step 22 if other conditions for this choice are met. If that is the case, connection to the local network takes place in a sixth step 23. Checking of feasible connection modes then continues by returning to the first step 17.

If the control in the fourth step 21 results in a circuit switching not being feasible, it is instead checked in a seventh step 24 if a wireless connection to a remote network is feasible. If that is the case, it is checked in an eighth step 25 if other conditions for this choice are met. If that is the case, connection to the remote network takes place in a ninth step 26. Control of feasible connection modes then continues by returning to the first step 17. Correspondingly, also additional connection possibilities may be checked and chosen.

The device according to the invention makes it possible for a user of a mobile computer without processor power of its own and without a set of user programs and data storing space of its own to continuously execute user programs in an external computer. At possible changeovers between connection modes, neither is the execution nor is the information that is indicated on the output member 16 affected A resource-efficient connection may continuously be maintained at a lowest cost.

1. a method in a mobile computer (20) comprising a control unit (10) and a plurality of communication members (12; 13; 14), characterized by
establishing a first connection between the computer and a server (11) through a first communication member (12; 13; 14),
executing a user program in the server, the user program transmitting output data for indication at the mobile computer via the first connection, and the mobile computer transmitting input data to the user program via the first connection,
continuously monitoring the status of the different communication members and which connections that are feasible,
replacing the first connection with a second connection depending on adjustable conditions and
transferring henceforth input data and output data via the second connection during continued indication of output data a the mobile computer and during continued monitoring of the status of the different communication members:

2. A method according to claim 1, further including the steps of indicating feasible connections between the computer and the server on an output member (16) of the mobile computer and setting one by affecting an input member (15) of the mobile computer.

3. A device in a mobile computer (20), characterized in
that a control unit (10) is operatively connected to a plurality of connecting units (12, 13, 14),
that the connecting units (12, 13, 14) are designed for continuously checking the connection with an external computer (11) and
that the control unit (10) is designed to continuously monitor the status of the different communication members and which connections that are feasible, and depending on adjustable conditions, to establish contact between the mobile computer and an external computer (11) via a selected connecting unit.
